(19) United States
(12) Patent Application Publication
(10) Pub. No.: US 2010/0314452 A1
(43) Pub. Date: Dec. 16, 2010

(54) APPARATUS AND METHOD OF GENERATING WAKE-UP SIGNAL IN BATTERY-POWERED PASSIVE TAG

(75) Inventors: Junho Yeo, Daegu-city (KR); Josef Preishub, Klagenfurt (AT); Alex Janek, Graz (AT); Andreas Schuhai, Portschach (AT); Hae-Won Son, Daejeon-city (KR); Jae-Young Jung, Daejeon-city (KR); Hee-Sook Mo, Daejeon-city (KR); Ji-Hoon Bae, Daejeon-city (KR); Gil-Young Choi, Daejeon-city (KR); Cheol-Sig Pyo, Daejeon-city (KR); Jong-Suk Chae, Daejeon-city (KR)

Correspondence Address: AMPACC Law Group, 3500 188th Street S.W., Suite 103, Lynnwood, WA, 98037, US

(73) Assignee: Electronics and Telecommunications Research Institute, Daejeon-city (KR)

(21) Appl. No.: 12/518,099

(22) PCT Filed: Dec. 7, 2007
(86) PCT No.: PCT/KR2007/006379

§ 371 Date: Jun. 5, 2009

(30) Foreign Application Priority Data
Dec. 8, 2006 (KR) 10-2006-0125033
Nov. 30, 2007 (KR) 10-2007-0123646

(51) Int. Cl. G06K 19/06

(52) U.S. Cl. 235/492

(57) ABSTRACT

An apparatus and method of generating a wake-up signal from a passive tag with a battery is provided. According to the present invention, since a wake-up signal is generated by a signal received from a Radio Frequency Identification (RFID) reader, battery life can be extended. That is, a wake-up signal can be generated for the battery to be operated according to a signal from the RFID reader so that the battery included in the tag can be controlled from the RFID reader, thereby controlling the amount of battery power consumed. Therefore, the battery life and the life of the tag including the battery can be increased.

### TECHNICAL FIELD

The present invention relates to a Radio Frequency Identification (RFID) tag, and more particularly, to an apparatus and method of generating a wake-up signal in a battery-powered passive tag which compares a signal from a RFID reader with a reference signal and controls activation of a tag.

The present invention was supported by the Information Technology (IT) Research & Development (R&D) program of the Ministry of Information and Communication (MIC) and the Institute for Information Technology Advancement (IITA), Republic of Korea. [Project No. 2005-S-106-02, Project Title: Developed technologies of a sensor tag and a sensor node for RFID/USN].

This application claims the benefit of Korean Patent Application No. 10-2006-0125033, filed on Dec. 8, 2006, and Korean Patent Application No. 10-2007-0123646 filed on Nov. 30, 2007 in the Korean Intellectual Property Office, the disclosure of which is incorporated herein in its entirety by reference.

### BACKGROUND ART

Radio Frequency Identification (RFID) is a process or chip which puts information about processes of producing, distributing, storing, and selling products into a tag attached to the products, has its own antenna, connects with an artificial satellite or uses mobile communication in order to access an information system, and a RFID reader reads the information.

Meanwhile, a RFID system includes a tag and a reader, wherein the tag stores information and exchanges data according to a protocol and the reader communicates with the tag.

The RFID tag can be classified into an active type, a passive type, and a hybrid type, wherein the active type needs a power source, the passive type is operated by an electromagnetic field of the reader, and the hybrid type is a form that combines advantages of the active and passive types.

By using the active type, required power is reduced and an identification distance may be far from the reader. However, since a power supply device is needed, the operation time is limited and the cost of the active type is more expensive than the passive type. On the other hand, the passive type is lighter than the active type, the cost of the passive type is less than the active type, and the passive type can be used semipermanently. However, when the passive type is used, the identification distance is short and more power is consumed by the reader, compared to when the active type is used.

In addition, when the hybrid type, which can be regarded as a battery powered passive tag, is used, the identification distance is improved by onboard batteries as in the active type and the RF power can be provided from the reader as in the passive type so that the hybrid type can be used semi-permanently.

Meanwhile, the battery powered passive tag periodically generates a wake-up signal at a specific time interval by using a timing signal of a low frequency oscillator, for example, a real time clock (RTC), and supplies power from the battery to a reader, particularly to an RF sender/receiver which communicates with the reader, based on the wake-up signal. Accordingly, the RF sender/receiver inspects whether a signal received from the reader exists.

However, according to the battery powered passive tag, regardless of communication with the reader, power from the battery is unnecessarily consumed by the wake-up signal that is generated periodically so that the battery life and life of the tag including the battery are reduced.

### DISCLOSURE OF INVENTION

### Technical Problem

The present invention provides an apparatus for generating a wake-up signal in a battery-powered passive tag, which maximizes power consumption efficiency so as not to reduce the battery life of a tag.

Other objects and advantages of the present invention will be understood by the description below and will be clearer by embodiments of the present invention. In addition, it will be understood that objects and advantages of the present invention can be executed by means and combinations thereof illustrated in claims.

### Technical Solution

According to the present invention, since a wake-up signal is generated by a signal received from a Radio Frequency Identification (RFID) reader, battery life can be extended. That is, a wake-up signal can be generated for the battery to be operated according to a signal from the RFID reader so that the battery included in the tag can be controlled from the RFID reader, thereby controlling the amount of battery power consumed. Therefore, the battery life and the life of the tag including the battery can be increased.

### ADVANTAGEOUS EFFECTS

According to the present invention, since a wake-up signal is generated by a signal received from the RFID reader, the life of the battery can be extended. That is, a wake-up signal can be generated for the battery to be operated according to a signal from the RFID reader so that the battery included in the tag can be controlled from the RFID reader, thereby controlling the amount of battery power consumed. Therefore, the life of the battery and the life of the tag including the battery can be extended.

### DESCRIPTION OF DRAWINGS

The above and other features and advantages of the present invention will become more apparent by describing in detail exemplary embodiments thereof with reference to the attached drawings in which:

FIG. 1 is a diagram schematically illustrating an activation command transmitted from a Radio Frequency Identification (RFID) reader according to an embodiment of the present invention;

FIG. 2 is a block diagram of an apparatus for generating a wake-up signal in a battery powered passive tag according to an embodiment of the present invention;

FIG. 3 is a block diagram of a second signal detector of FIG. 2 by clearly stating names of signal lines according to an embodiment of the present invention;

FIG. 4 illustrates waveforms of signals generated from an apparatus for generating a wake-up signal in the battery powered passive tag, according to an embodiment of the present invention;

FIG. 5 illustrates other waveforms of signals generated from an apparatus for generating a wake-up signal in the battery-powered passive tag, according to an embodiment of the present invention; and

FIG. 6 is a flowchart of a method of generating a wake-up signal in a battery-powered passive tag according to an embodiment of the present invention.

### BEST MODE

According to an aspect of the present invention, there is provided an apparatus for generating a wake-up signal from a passive tag with a battery, the apparatus including: a signal detector which measures a period of a pulse or the maintaining time of a pulse according to a coding mechanism of an input signal from a Radio Frequency Identification (RFID) reader and generates a wake-up signal, when the input signal is a activation command signal; and a controller which activates a power supply function of the battery by the wake-up signal.

According to another aspect of the present invention, there is provided a method of generating a wake-up signal from a passive tag with a battery, the method including: measuring a period of a pulse or the maintaining time of a pulse according to a coding mechanism of an input signal from a Radio Frequency Identification (RFID) reader and generating a wake-up signal, when the input signal is a activation command signal; and activating a power supply function of the battery by the wake-up signal.

The present invention may provide a computer readable recording medium having embodied thereon a computer program for executing the method above.

### MODE FOR INVENTION

Hereinafter, the present invention will be described more fully with reference to the accompanying drawings, in which exemplary embodiments of the invention are shown. In the drawings, like reference numerals in the drawings denote like elements. In the description of the present invention, if it is determined that a detailed description of commonly-used functions or structures related to the invention may unintentionally obscure the subject matter of the invention, the detailed description will be omitted.

In addition, when a certain part ‘includes’ or ‘comprises’ a certain element, it is understood that other elements can be further added, instead of excluding other elements, as long as there is no specific opposition.

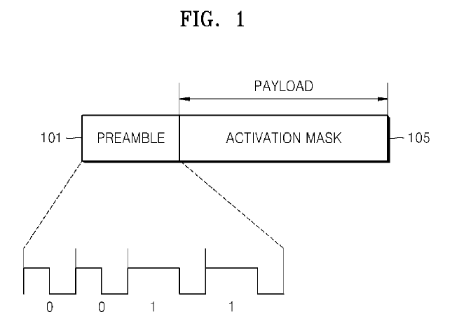

FIG. 1 is a diagram schematically illustrating an activation command transmitted from a Radio Frequency Identification (RFID) reader according to an embodiment of the present invention.

In the present invention, only when a simple wake-up preamble signal or an activation command signal which matches an activation code that is pre-stored in a tag is received from the RFID reader, operation of a battery is activated so that energy can be saved and the life of the battery can be extended.

Battery assisted tags (BAT)(or Battery powered tags) need to be protected from excessive battery leakage due to unnecessary decoding activities caused by nearby passive communication. Battery assisted tags may therefore remain in a hibernate state saving energy until receiving an Activation Command containing a valid Activation Mask, that matches the Activation Code stored in the reserved memory of the tag. In that case the tag may be activated and switch to a working mode similar to passive tags until being deactivated.

Moreover, the Activation Command can be used to activate a subset of a tag population by means of prefix matching to avoid unintended wake up of different purpose tags situated in the same environment.

Non selective activation of all BAT within the range of the RFID reader is also supported by issuing a wildcard (WC).

Referring to FIG. 1, the activation command includes an activation preamble 101 and an activation mask 105 which forms a payload.

The activation preamble 101 has specific data value, for example, two successive binary 0 and two successive binary 1. When a preamble data value of a received signal has pre-agreed specific data value, the tag determines the received signal as the activation command. Here, the tag identifies data value of a preamble signal by a partial operation of a chip included in the tag and the battery of the tag is deactivated.

When the received signal is determined as the activation command, the activation mask 105 is demodulated and is compared with an activation code that is pre-stored in the tag. When the activation mask 105 matches the activation code, the battery of the tag is activated.

The Activation Code (AC) is either a randomly chosen value or the UII (Unique item Identifier) or part thereof. The length of the AC may be chosen between 0 and 96 bits. The Minimum Mask Length (MML) controls the minimum value that can be used for the length field. The minimum mask length register is the minimum amount of bits necessary to match a mask.

Battery assisted tags supporting the Activation Command may provide a 32-bit AC

Address pointing to the memory location where the Activation Code can be found. The AC Address may be stored in the TID memory (memory bank 10₂) starting at memory word 22ₕ MSB first subsequent to the SAM Address.

Referring to table 1, the AC address may comprise 6 bits reserved for future use (RFU) followed by 2 bits identifying the memory bank (MB) where the MML and AC is stored, and a 24 bit EBV (Extensible bit vector) specifying the start address of the MML and AC.

The first 16 bit word may contain the 7 bits of MML in the 7 LSB's of the word. The next six 16 bit words may contain the AC which can be up to 96 bits.

TABLE 1

| | RFU | MB | Address |
|---|---|---|---|
| Bits | 6 | 2 | 24 |
| Description | Reserved | Memory bank | Start address |
| | for future | selector | of AC (EBV) |

In order to save energy, for operation in the Activation code check state a tag may copy the AC from the above described memory positions into a low-power register. The default value for the Activation Code may be 0. Once programmed, every BAT implementing the Activation Mechanism may contain an Activation Code greater than 0.

It is recommended that the activation protocol is kept as simple as possible consisting of a single Activation Command. No tag response is required. Activation is governed by an 8-96 bit Activation Mask, required to match the 8-96 bit Activation Code stored in the tag. The Activation Mask is not a password and is transmitted in plaintext. The Activation Command may comprise a preamble followed by a variable length Activation Mask used to specify the addressee of the wake up call.

In order to ensure power drain is reduced to a minimum while a tag remains in state Hibernate, the demodulation and decoding of the Activation Command may be carried out by a circuitry consuming significantly less energy than then the circuitry required to demodulate and decode passive commands. The clock-rate of the activation circuitry may be chosen so that it can demodulate and decode commands transmitted using the signaling.

It is recommended that only the parts of the tag ASIC necessary for interpreting the Activation Command remain powered in state Hibernate.

RFID readers may transmit the Activation Command using DS-ASK (Double Side Band-Amplitude Shift Keying), SSB-ASK (Single Side Band-ASK) or PR-ASK (Phase Reverse-ASK) with a modulation depth of 80-100%.

Pulse Interval Encoding (PIE) Symbols may be used to encode the Activation Command. For example, the reference time interval for the data-0 symbol may be Tari=125 μs+/−2%, and the data-1 symbol may be 1.5Tari≦data-1≦2.0Tari.

The minimum length of the Activation Mask may be 8 bits and the maximum length of the Activation Mask may be 96 bits. The Activation Mask may be transmitted MSB first.

Tags may bitwise compare the received Activation Mask with the Activation Code and may immediately drop back to state Hibernate if a mismatch is detected. If the Activation Mask matches each single bit of the Activation Code, the activation is successful and the tag may turn on his PIE-decoder and expect the beginning of an inventory round.

If the Activation Mask is chosen to be shorter than the Activation Code actually implemented by the tag, a successful prefix matching with the Activation Code will be required to activate the tag.

Battery assisted tags may implement a lower threshold for the length of the AMSK to be accepted.

In case the Activation Mask is chosen to be longer than the Activation Code implemented by a tag, the tag may immediately drop back to state hibernate because the wake up command has been intended for a different addressee implementing a longer Activation Code.

To activate all battery assisted tags within a population at once, a wildcard may be issued by the RFID reader. The term wildcard denotes a special Activation Mask, for example, consisting of 8 subsequent zeros (data-0). Wildcard recognition may be independent from the actual value of the AC stored in BAT, in particular the default value for the AC is not part of the wildcard concept and therefore wildcard recognition does not end with the programming of the AC.

Although wildcard activation is an optional feature it is recommended that battery assisted tags implementing Activation support the use of the wildcard.

Table 2 illustrates examples of matched/unmatched for the activation mask and the activation code.

TABLE 2

| | Binary | Matched/ |
|---|---|---|
| Items | Representation | Unmatched |
| Activation Mask | 1010 0000 00100 | |
| Activation Code (Tag 1) | 1010 0000 001001 | Matched |
| Activation Code (Tag 2) | 1010 0000 00101 | Unmatched |
| Activation Code (Tag 3) | 1010 0000 0010 | Unmatched |

Tags implementing the Activation Mechanism may remain in state ‘Hibernate’ until the presence of an activation command preamble, switch to an intermediate state called ‘Activation code check’, while decoding the Activation Command, and after the tag activation time T_{A} reach the state ‘Ready’ in case of successful activation, which is the initial state for passive tags after powering up.

The tag activation time T_{A} is the time required to finish the activation code check and fully power-up the tag so that it is ready to receive a Select or Query command. The maximum tag activation time T_{A} is 6*Tbit=750 μs.

Once activated, BAT may behave like purely passive tags except specified differently.

In order to save energy, battery assisted tags may automatically fall back into the Hibernate state after activation and a succeeding period of inactivity greater than an Inactivity Threshold (INACT_T) which may be 50 ms≦INACT_T≦100 ms. Inactivity means that a tag in the Ready state does not receive a command which causes it to participate in an inventory round.

After a reader identified a battery assisted tag and no longer needs to access the battery assisted tag, the reader may use the Deactivate_BAT command to put the tag back into the Hibernate state.

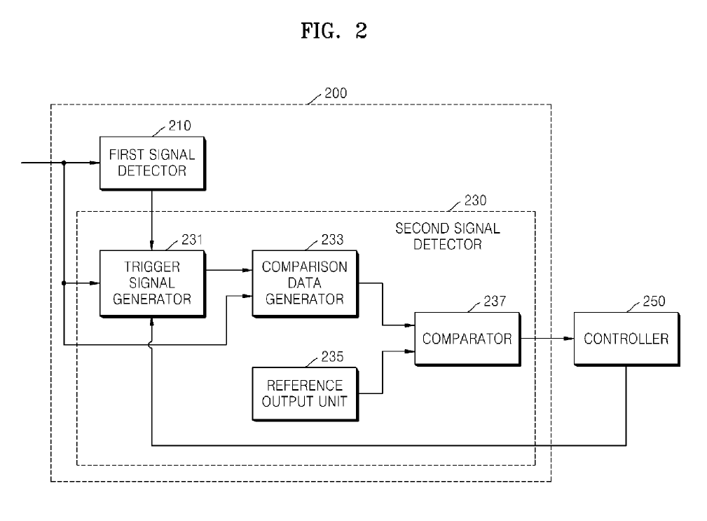

FIG. 2 is a block diagram of an apparatus for generating a wake-up signal in a battery powered passive tag according to an embodiment of the present invention.

The apparatus for generating a wake-up signal includes a signal detector 200 and a controller 250.

The signal detector 200 measures a period of a pulse or the maintaining time of a pulse according to a coding mechanism of a signal received from the RFID reader and generates a wake-up signal when the received signal is an activation command signal.

The signal detector 200 includes a first signal detector 210 and a second signal detector 230.

When a preamble data value of the received signal has specific data value, the first signal detector 210 determines the received signal as the activation command and generates an activation check signal for modulating the activation mask carried by the payload.

The second signal detector 230 demodulates the activation mask of the received signal by the activation check signal and compares the modulated activation mask with the activation code that is pre-stored. According to the comparison, when the activation mask matches the activation code, the second signal detector 230 generates a wake-up signal. The second signal detector 230 compares successive data value of the modulated activation mask with successive data value of the activation code or compares accumulated values of successive data value of the activation mask with specific data value of the activation code.

The second signal detector 230 includes a trigger signal generator 231, a comparison data generator 233, a reference output unit 235, and a comparator 237. The trigger signal generator 231 measures a period of a pulse or the maintaining time of a pulse according to a coding mechanism of an input signal pulse and generates a trigger signal which indicates that a specific data value is input as a binary 1. The comparison data generator 233 generates wake-up data from the trigger signal generated from the trigger signal generator 231 and the input signal. The reference output unit 235 outputs reference data which corresponds to the activation code. The comparator 237 generates a wake-up signal when wake-up data generated from the comparison data generator 233 matches reference data output from the reference output unit 235.

The controller 250 activates a power supply function of the battery by the wake-up signal output from the comparator 237. When wake-up data and the reference data are not matched, the controller 250 determines that the activation command is not a command for itself and thus stops operation of the trigger signal generator 231, thereby maintaining deactivation of the tag.

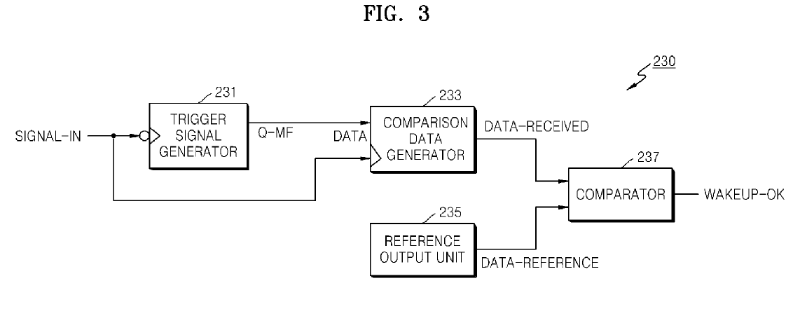

FIG. 3 is a block diagram of the second signal detector 230 of FIG. 2 by clearly stating names of signal lines according to an embodiment of the present invention. All elements in FIG. 3 are the same as FIG. 2.

Hereinafter, generation of a wake-up signal, which activates the battery to supply power by using the signal names illustrated in FIG. 3, is described. As will be described below, a wake-up signal is generated based on a ‘wake-up generation mechanism’ in which the RFID reader and a pre-set wake-up preamble signal are used.

The wake-up generation mechanism may be at least one of a Pulse Interval Encoded (PIE) preamble technique and a Pulse Length Modulation (PLM) preamble technique and signal detection is based on a mono-flop circuit.

In addition, it is preferable that the wake-up generation mechanism is stopped by a special command (for example, a deactivation command) received from the RFID reader or by the elapse of a pre-set timeout.

In other words, when the trigger signal generator 231 receives the pre-set special command from the RFID reader or when the pre-set time is reached, trigger signal generations is stopped by a control signal of the controller 250.

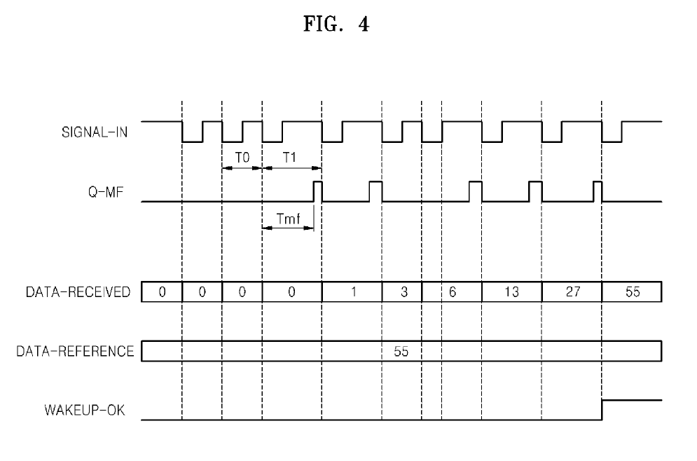

FIG. 4 illustrates waveforms of signals generated from an apparatus for generating a wake-up signal in the battery powered passive tag, according to an embodiment of the present invention. The PIE preamble mechanism is described with reference to FIG. 4. The PIE preamble mechanism is a coding method in which the maintaining times of a pulse are different in representing binary data 0 and 1. Accordingly, periods of a pulse with respect to data 0 and data 1 are different and a period of data 1 is generally longer.

Firstly, when the signal (Signal-in) input by the activation check signal output from the first signal detector 210 is successively input to one period of a pulse ‘T0 (Binary 0)’ and one period of a pulse ‘T1 (Binary 1)’ according to the PIE preamble mechanism, the trigger signal generator 231 generates a trigger signal Q-MF at a falling edge of ‘T1’. In this case, based on the falling edge of the trigger signal, other elements such as the comparison data generator 233 start their performance so that trigger signal generation indicates the falling edge of the trigger signal at that point. The signal (Signal-in) is the activation mask of the activation command.

Here, T0<Tmf<T1 should be established as a prior condition for trigger signal Q-MF generation.

In other words, when binary 0 and binary 1 are successively input according to the PIE preamble mechanism, the trigger signal generator 231 measures the period of a pulse and generates the trigger signal only with respect to binary 1 and maintains the trigger signal until the period of binary 1 is completed. Accordingly, T0<Tmf<Ti should be established, where Tmf is the time from when the pulse of binary 1 starts to when the trigger signal is generated.

The comparison data generator 233 generates a wake-up data signal Data-received which corresponds to the activation mask based on the signal Signal-In and the trigger signal Q-MF. The comparison data generator 233 can be embodied by using a device such as a serial shift register.

Then, the comparator 237 compares the wake-up data Data-received input from the comparison data generator 233 with reference data Data-reference which corresponds to the activation code input from the reference output unit 235. When they are matched, the comparator 237 outputs a wake-up signal Wakeup_OK. Whether each value of the wake-up data completely matches each value of the reference data or whether accumulation values of the wake-up data completely match a specific data value of the reference data is considered to determine whether data are matched. In the former case, when the length of the wake-up data is same with or shorter than the length of the reference data, the comparator 237 determines whether the wake-up data matches the reference data and when the length of the wake-up data is longer than the length of the reference data, the comparator 237 can stop generation of the trigger signal. When the length of the wake-up data is shorter than the length of the reference data, it can be determined by considering whether the wake-up data is identical with a prefix of the reference data.

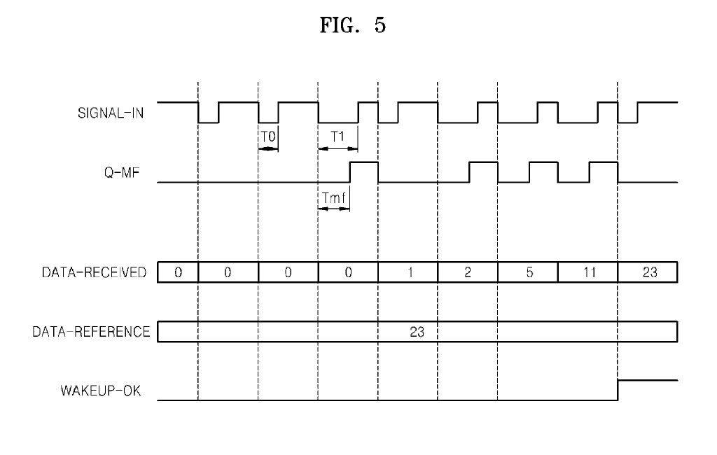

FIG. 5 illustrates other waveforms of signals generated in the apparatus for generating a wake-up signal in a battery powered passive tag, according to an embodiment of the present invention. The PLM preamble mechanism is described with reference to FIG. 5. Unlike the PIE preamble mechanism, the PLM preamble mechanism is a coding method in which periods of a pulse are the same in representing data 0 and data 1. However, a width of a pulse is different in terms of periods. In this case, it is defined that the time in which a width of a pulse of data 0 is subtracted from a period of a pulse is ‘T0’ and the time in which a width of a pulse of data 1 is subtracted from a period of a pulse is ‘T1.’ T1 is longer than T0.

Firstly, when a pulse corresponding to T0 (binary 0) and a pulse corresponding to T1 (binary 1) are successively input according to the PLM preamble mechanism of the signal Signal-in by the activation check signal output from the first signal detector 210, the trigger signal generator 231 generates the trigger signal Q-MF at the falling edge of the pulse having T1. Here, T0<Tmf<T1 should be established as a prior condition for trigger signal Q-MF generation.

That is, when binary 0 and binary 1 according to the PLM preamble mechanism are successively input to the signal of the activation mask, the trigger signal generator 231 measures the time starting from a period of a pulse to a rising edge of a pulse and generates the trigger signal with respect to binary 1 and maintains the trigger signal until the period of binary 1 is completed. Accordingly, if the time from when the pulse of binary 1 starts to when the trigger signal is generated is called Tmf, T0<Tmf<T1 should be established.

The comparison data generator 233 generates a wake-up data signal Data-received that corresponds to the activation mask based on the signal Signal-In and the trigger signal Q-MF. The comparator 237 compares the wake-up data signal Data-received input from the comparison data generator 233 with reference data Data-reference that corresponds to the activation code input from the reference output unit 235. If they are same, the comparator 237 outputs a wake-up signal Wakeup_OK. Whether each value of the wake-up data completely matches each value of the reference data or whether accumulation values of the wake-up data completely match a specific data value of the reference data is considered to determine whether data are matched. In the former case, when the length of the wake-up data is same with or shorter than the length of the reference data, the comparator 237 determines whether the wake-up data matches the reference data and when the length of the wake-up data is longer than the length of the reference data, the comparator 237 can stop generation of a trigger signal. When the length of the wake-up data is shorter than the length of the reference data, it can be determined by considering whether the wake-up data is identical with a prefix of the reference data.

Consequently, in the present invention, a wake-up signal can be generated for the battery to be operated according to a simple wake-up preamble signal from the RFID reader, that is, the activation command, and thus the battery included in the tag can be controlled from the RFID reader, thereby controlling the amount of battery power consumed. Accordingly, the life of the battery and the life of the tag including the battery can be extended.

Meanwhile, the PIE preamble mechanism and the PLM preamble mechanism illustrated in FIGS. 4 and 5 can be applied to identifying preamble data in the first signal detector 210 illustrated with reference to FIG. 1 and thus detailed description thereof is omitted.

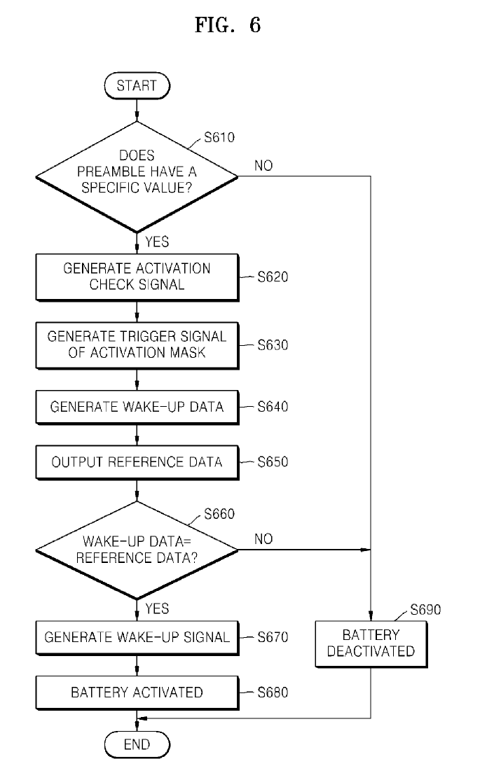

FIG. 6 is a flowchart of a method of generating a wake-up signal in a battery-powered passive tag according to an embodiment of the present invention. The detailed description which is overlapped with the description above will be omitted.

Referring to FIG. 6, the tag measures a period of a pulse or the maintaining time of a pulse according to a coding mechanism of the signal received from the RFID reader. When the received signal is the activation command signal, the tag generates the wake-up signal and a power supply function of the battery is activated by the wake-up signal.

First, the first signal detector of the tag determines that the preamble of the signal input from the RFID reader has a specific data value in operation 610. The signal detector can determine whether a binary data value generated by measuring a period of a pulse or the maintaining time of a pulse has a specific value.

When the preamble has a specific data, the first signal detector determines the input signal as the activation command and generates the activation check signal for comparing the activation mask with the activation code in operation 620.

The second signal detector measures a period of a pulse or the maintaining time of a pulse of the activation mask to generates the trigger signal at binary data 1 in operation 630 and generates wake-up data based on the trigger signal and the input signal in operation 640.

In operation 650, the second signal detector outputs reference data which corresponds to pre-stored activation code and determines whether the wake-up data matches the reference data in operation 660.

When the wake-up data and the reference data are matched, the second signal detector generates the wake-up signal. Whether each value of the wake-up data completely matches each value of the reference data or whether accumulation values of the wake-up data completely match a specific data value of the reference data is considered to determine whether data are matched. In the former case, when the length of the wake-up data is same with or shorter than the length of the reference data, the second signal detector determines whether the wake-up data matches the reference data and when the length of the wake-up data is longer than the length of the reference data, the second signal detector can stop generation of the trigger signal. When the length of the wake-up data is shorter than the length of the reference data, it can be determined by considering whether the wake-up data is identical with a prefix of the reference data.

When the preamble does not have a specific data value in operation 610, the battery is continuously deactivated so that the tag maintains a resting state in operation 690.

In the present invention, the activation command is divided into the preamble and the payload, and preamble data and successive data of the payload are identified to generate the wake-up signal. Also, the wake-up signal can be generated by once identifying a series of pulses that is successively input as one preamble signal without dividing the activation command. In the latter case, the operation of the first signal detector described above can be omitted.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skill in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purpose of limitation. Therefore, the scope of the invention is defined not by the detailed description of the invention but by the following claims, and all differences within the scope will be construed as being included in the present invention.

1. An apparatus for generating a wake-up signal from a passive tag with a battery, the apparatus comprising:
a signal detector which measures a period of a pulse or the maintaining time of a pulse according to a coding mechanism of an input signal from a Radio Frequency Identification (RFID) reader and generates a wake-up signal, when the input signal is a activation command signal; and
a controller which activates a power supply function of the battery by the wake-up signal.

2. The apparatus of claim 1, wherein the signal detector comprises:
a first signal detector which determines the input signal as the activation command signal when a preamble of the input signal has a specific data value, and generates an activation check signal; and
a second signal detector which compares an activation mask of the input signal with a pre-stored activation code by the activation check signal and generates the wake-up signal, when the activation mask matches the activation code.

3. The apparatus of claim 2, wherein the first signal detector generates the activation check signal when data generated by measuring a period of a preamble pulse or the maintaining time of a preamble pulse of the input signal has a specific value.

4. The apparatus of claim 2, wherein the second signal detector comprises:
a trigger signal generator which measures a period of a pulse or the maintaining time of a pulse of the activation mask of the input signal and generates a trigger signal at binary data 1;
a comparison data generator which generates wake-up data based on the trigger signal and the activation mask;
a reference output unit which outputs reference data which corresponds to the activation code; and
a comparator which generates the wake-up signal when the wake-up data and the reference data are matched.

5. The apparatus of claim 4, wherein when binary 0 and binary 1, each having different pulse periods, are successively input in the input signal, the trigger signal generator generates the trigger signal only with respect to binary 1 and maintains the trigger signal until the period of binary 1 is completed.

6. The apparatus of claim 2, wherein in the input signal, if a period of the pulse with respect to binary 0 is ‘T0’, if a period of the pulse with respect to binary 1 is ‘T1’, and if a time from when the pulse of binary 1 starts to when the trigger signal is generated is Tmf, T0<Tmf<T1 is established.

7. The apparatus of claim 4, wherein when binary 0 and binary 1 having the same pulse periods and different pulse maintaining times are successively input in the input signal, the trigger signal generator generates the trigger signal only with respect to binary 1 and maintains the trigger signal until the period of binary 1 is completed.

8. The apparatus of claim 4, wherein in the input signal, if a maintaining time of the pulse with respect to binary 0 is ‘T0’, if a maintaining time of the pulse with respect to binary 1 is ‘T1’, and if a time from when the pulse of binary 1 starts to when the trigger signal is generated is Tmf, T0<Tmf<T1 is established.

9. The apparatus of claim 4, wherein the comparator compares the wake-up data and successive data of the reference data or compares an accumulation value of successive wake-up data with a specific value of the reference data to determine whether data are matched.

10. The apparatus of claim 4, wherein when the length of the wake-up data is shorter than the length of the reference data, the comparator determines whether the wake-up data matches the reference data and when the length of the wake-up data is longer than the length of the reference data, the comparator stops generation of the trigger signals.

11. The apparatus of claim 1, wherein when the passive tag receives a deactivation command from the RFID reader or a pre-set time is elapse, the controller stops the activation.

12. A method of generating a wake-up signal from a passive tag with a battery, the method comprising:
(a) measuring a period of a pulse or the maintaining time of a pulse according to a coding mechanism of an input signal from a Radio Frequency Identification (RFID) reader and generating a wake-up signal, when the input signal is a activation command signal; and
(b) activating a power supply function of the battery by the wake-up signal.

13. The method of claim 12, wherein (a) comprises:
(a1) when a preamble of the input signal has a specific data value, determining the input signal as the activation command signal and generating an activation check signal; and
(a2) comparing an activation mask of the input signal with a pre-stored activation code by the activation check signal and generating the wake-up signal, when the activation mask matches the activation code.

14. The method of claim 13, wherein (a1) comprises generating the activation check signal when data generated by measuring a period of a preamble pulse or the maintaining time of a preamble pulse of the input signal has a specific value.

15. The method of claim 13, wherein (a2) comprises:
measuring a period of a pulse or the maintaining time of a pulse of the activation mask of the input signal and generating a trigger signal at binary data 1;
generating wake-up data based on the trigger signal and the activation mask;
outputting reference data which corresponds to the activation code; and
generating the wake-up signal when the wake-up data and the reference data are matched.

16. The method of claim 15, wherein when binary 0 and binary 1, each having different pulse periods, are successively input in the input signal, the trigger signal is generated only with respect to binary 1 and is maintained until the period of binary 1 is completed.

17. The method of claim 16, wherein in the input signal, if a period of the pulse with respect to binary 0 is ‘T0’, if a period of the pulse with respect to binary 1 is ‘T1’, and if a time from when the pulse of binary 1 starts to when the trigger signal is generated is Tmf, T0<Tmf<T1 is established.

18. The method of claim 15, wherein when binary 0 and binary 1 having the same pulse periods and different pulse maintaining times are successively input in the input signal, the trigger signal is generated only with respect to binary 1 and is maintained until the period of binary 1 is completed.

19. The method of claim 18, wherein in the input signal, if a maintaining time of the pulse with respect to binary 0 is ‘T0’, if a maintaining time of the pulse with respect to binary 1 is ‘T1’, and if a time from when the pulse of binary 1 starts to when the trigger signal is generated is Tmf, T0<Tmf<T1 is established.

20. The method of claim 15, wherein the generating the wake-up signal comprises comparing the wake-up data and successive data of the reference data or comparing an accumulation value of successive wake-up data with a specific value of the reference data to determine whether data are matched.

21. The method of claim 20, wherein the generating the wake-up signal comprises determining whether the wake-up data matches the reference data when the length of the wake-up data is shorter than the length of the reference data and stopping generation of the trigger signals when the length of the wake-up data is longer than the length of the reference data.
